(19) United States
(12) Patent Application Publication
(10) Pub. No.: US 2026/0367004 A1
(43) Pub. Date: Nov. 19, 2026

(54) OPTICAL DETECTION DEVICE AND METHOD OF OPERATION

(71) Applicant: Liom Health AG, Pfäffikon (CH)

(72) Inventors: Jens HOFRICHTER, Horgen (CH); Adler PEROTTE, Horgen (CH)

(73) Assignee: Liom Health AG, Pfäffikon (CH)

(21) Appl. No.: 19/158,756

(22) PCT Filed: Feb. 21, 2023
(86) PCT No.: PCT/EP2023/054330

§ 371 Date: Aug. 21, 2025

(51) Int. Cl. G01N 21/65

(52) U.S. Cl. CPC G01N 21/65; G01N 2201/06113

(57) ABSTRACT

A Raman detection device comprises an array of light emitters including first and second primary light emitters (11H, 11L) and a plurality of secondary light emitters (10Hk, 10Lk), with the optical frequencies of the secondary light emitters (10Hk, 10Lk) lying between the optical frequencies of the primary light emitters (11H, 11L). The array of light emitters is arranged between two arrays of light detectors (12H, 12L). The light detectors (12H, 12L) are covered by two light filters (14H, 14L). The light filters (14H, 14L) are bandpass filters for the frequencies of the first and second primary light emitters (11H, 11L). This device is suitable to perform and analyze a large number of different elastic and inelastic optical scattering processes on a sample or tissue.

### TECHNICAL FIELD

The invention relates to a Raman detection device as well as to a method for operating such a device.

### BACKGROUND ART

Elastic and inelastic interactions of photons with a sample can provide a wealth of information about the parameters of the sample.

Classes of interactions include various elastic and Raman-type interactions:
Elastic interactions: elastic scattering, absorption, and transmission at a given optical frequency.
Spontaneous Stokes or anti-Stokes Raman scattering: Here, a single photon interacts with the vibrational states of the molecules in the sample.
Coherent anti-Stokes Raman spectroscopy (CARS): In this process, three photons coherently interact with the vibrational states of the molecules.
Stimulated Raman gain and stimulated Raman loss (SRG, SRL): In this process, two photons coherently interact with the vibrational states of the molecules.

In addition, other types of interactions between photons and molecules can provide additional data for a given sample:
Fluorescent measurements: In fluorescence, a single photon interacts with an excited state and a ground state of a molecule as well as with vibrational sub-states of the molecule.
Spatially offset Raman measurements: This is a class of measurements that can be combined with any of the others mentioned here and is based on detecting the light returning from the sample at several different locations in relation to the light sources, which allows to gain more information on the internal structure of the sample.
Polarized measurements: This is a class of measurements that can be combined with any of the others mentioned here and is based on using polarized light to probe the sample.

There are various known devices optimized to perform one of these measurements.

### DISCLOSURE OF THE INVENTION

The problem to be solved is to provide a Raman detection device, i.e. a device suitable to detect Raman radiation from a sample, as well as a method for its operation, that deliver rich experimental data descriptive of the properties of the sample.

The problem is solved by the Raman detection device of claim 1.

Accordingly, the Raman detection device comprises at least the following elements:
A substrate: the substrate provides a common mount for the following elements.
A plurality of narrow-band light emitters: These emitters are integrated on the substrate. They are advantageously adapted to emit light from a first surface of the substrate. They are “narrow-band” in the sense that their spectral width is small enough to resolve Stokes and anti-Stokes frequency shifts. Advantageously, the light emitters have a full width at half maximum (FWHM) spectral width of less than 5 nm, in particular of less than 1 nm. More preferably, the light emitters have a FWHM spectral width of less than 100 pm.
A plurality of light detectors: The light detectors are also integrated on the substrate. They are advantageous arranged to receive light impinging on the first surface of the substrate.
At least a first filter: The first filter is arranged at at least a first set of the light detectors, i.e. the light impinging on said first set of light detectors has to pass the first filter.

The light emitters comprise at least a “first primary light emitter” having an emission maximum at a first optical emission frequency ω_{H}.

The light emitters further comprise at least a “first secondary light emitter”, i.e. a number K of first secondary light emitter(s), with K≥1. The secondary light emitter or emitters has/have an emission maximum at a second optical emission frequency/frequencies ω_{Hk}, with k being 1 to K. Further, ω_{H}≠ω_{Hk}.

Further, the first filter transmits light at ω_{H} and blocks light ω_{Hk} for all k. In this context, the terms “transmits” and “blocks” are to be understood such that the transmission of the first filter at ω_{H} is at least 10 times, in particular at least 100 times, most preferably at least 1000 times, larger than the transmission of the first filter at ω_{Hk}.

This type of device provides a well-defined positioning of the light emitters and detectors, and with its at least two light emitters in combination with the first filter it allows to measure a rich set of the above effects, including at least two of the following: spontaneous Stokes or anti-Stokes emission (by emitting light from the first secondary light emitter and detecting the light scattered back from the sample), elastic scattering (by emitting light from the first primary light emitter and detecting the light scattered back from the sample), stimulated Raman gain or loss (by emitting light from both emitters and detecting the light scattered back from the sample).

(Note: Although, in the embodiments below, the frequency ω_{H} of the first primary light emitter is larger than the frequency ω_{Hk} of the first secondary light emitter(s), this restriction does not apply to claim 1. Not does it apply to most of the dependent claims unless they are combined with a claim requiring that ω_{H}>ω_{Hk}.)

Advantageously, the difference between ω_{H} and ω_{Hk} is, for all k, no more than 4000 cm⁻¹ in order to correspond to at least one typical vibrational mode.

On the other hand, the difference between ω_{H} and ω_{Hk} is, for all k, advantageously
at least 50 cm⁻¹, in particular at least 100 cm⁻¹ and/or
at least the sum of the FWHM spectral widths of the first and first secondary light emitters.

For spectrally selective measurements and improved signal-to-noise ratio, the first filter is advantageously a bandpass filter having a transmission maximum at a first filter frequency ω_{fH} and a FWHM (full width half maximum) transmission window of less than 100cm- 1 , in particular less than 50 cm⁻¹.

In that case, the maximum emission frequency ω_{H} of the first primary light emitter is advantageously equal to the maximum transmission frequency ω_{fH} of the first filter in order for the filter to have a good transmission for the light from the first primary light emitter.

In a particularly advantageous embodiment, the device further comprises K “second secondary light emitters” with maximum emission frequencies ω_{Lk}. The frequencies ω_{Lk} are different from ω_{H} and from ω_{Hk} for all k=1 to K. This allows to perform even more Raman measurements as explained in more detail below.

The device may also comprise more than one first secondary light emitter and more than one second secondary light emitter, i.e. K>1. In this case, in order to perform measurements at a plurality of different wavelengths, ω_{Hk′}≠ω_{Hk″} and ω_{Lk′}≠ω_{Lk″} for k′≠k″.

Advantageously (for the case of K=1 as well as for the case of K>1), the first filter blocks at ω_{Hk} and ω_{Lk} for all k=1 to K, i.e. the transmission of the first filter at ω_{H} is at least 10 times, in particular at least 100 times, most preferably at least 1000 times, larger than the transmission of the first filter at ω_{Hk} and ω_{Lk}. For the reasons mentioned for ω_{H} above, this provides an even richer set of measurements.

Just as for ω_{Hk}, the frequency difference between ω_{H} and ω_{Lk} is, for all K, advantageously no more than 4000 cm⁻¹.

Similarly, this the frequency difference between ω_{H} and ω_{Lk} may be at least one of:
at least 50 cm⁻¹, in particular at least 100 cm⁻¹ for all k and/or
at least the sum of the FWHM of the first primary light emitter and the second secondary light emitter.

In one embodiment, ω_{Hk}>ω_{Lk} and ω_{H}>ω_{Lk}, for all k.

Advantageously, ω_{Hk}>ω_{Lk} and the frequency difference between ω_{Hk} and ω_{Lk} is equal to a frequency difference between ω_{fH} and ω_{Hk}. This design allows to measure coherent anti-Stokes Raman scattering (CARS) by using the light at ω_{Hk} as a pump and probe beam and the light from at ω_{Lk} as a Stokes beam.

In yet a further embodiment providing even more options for performing measurements, the device may comprise at least one second primary light emitter having an emission maximum at an emission frequency ω_{L}, with ω_{L} being, for all k, different from ω_{Hk} and from ω_{H}.

The frequency difference between ω_{H} and ω_{L} is advantageously no more than 4000 cm₋₁ and/or at least
at least 50 cm⁻¹, in particular at least 100 cm⁻¹ and/or
the sum of the FWHM of the first primary light emitter and the second primary light emitter.

If one or more second secondary light emitter(s) is/are present in the device, the frequency difference between ω_{Lk} and ω_{L} is advantageously no more than 4000 cm⁻¹ and/or at least
at least 50 cm⁻¹, in particular at least 100 cm⁻¹ for all k
the sum of the FWHM of the second secondary light emitter and the second primary light emitters for all k.

The device advantageously comprises a second filter arranged at at least a second set of the light detectors for filtering the light arriving at the second set of light detectors. The second filter has a spectral transmission different from the first filter.

If the device has a “second primary light emitter” with a maximum emission frequency ω_{L} as mentioned above, the second filter is advantageously matched with the second primary light emitter, i.e. it transmits light at ω_{L} and blocks light ω_{H} and ω_{Hk} (as well as ω_{Lk} if second secondary light emitters are present) while the first filter blocks @L, with the terms “transmit” and “block” again being defined as above, i.e. the transmission at a transmitted frequency is at least 10 times, in particular at least 100 times, most preferably at least 1000 times, larger than the transmission at a blocked frequency. In this case, the first filter can be used to selectively measure the light at ω_{H} while the second filter can be used to selectively measure the light at ω_{L}.

Advantageously, the first and second filters are located on the substrate with a gap between them, i.e. with an elongate region extending between them that is neither covered by the first filter nor by the second filter. In this case, at least part of the light emitters are located in said gap. This provides a compact design where the emitters can be close to the detectors. Advantageously, at least all of the secondary light emitters are arranged in the gap.

Advantageously, the light detectors are located at a plurality of different distances from said first primary light emitter and said first secondary light emitter. This allows performing spatially offset measurements, in particular Spatially Offset Raman Spectroscopy (SORS) measurements. If there is a second primary light emitter and/or a second secondary light emitter, the light detectors are, advantageously, also located at a plurality of different distances from said second primary light emitter and said second secondary light emitter.

The invention also relates to a method for operating this type of device. Said method comprises at least the following steps:
Emitting light from at least one of the light emitters into a sample.
Measuring light returning from the sample by means of one or more of the light detectors, and
Deriving at least one parameter of said sample from a signal of the light detectors.

### BRIEF DESCRIPTION OF THE DRAWINGS

The invention will be better understood and objects other than those set forth above will become apparent when consideration is given to the following de-tailed description thereof. Such description makes reference to the annexed drawings, wherein:

FIG. 1 shows a top view of a device,

FIG. 2 shows a sectional view along line II-II of FIG. 1,

FIG. 3 illustrates a possible arrangement of the light emitters in more detail,

FIG. 4 is an illustration of the frequencies of the light emitters and the filters,

FIG. 5 a block circuit diagram of the device, and

FIG. 6 is a second embodiment of an array of light emitters.

### MODES FOR CARRYING OUT THE INVENTION

### Geometric Design

The present device is adapted to measure various inelastic and/or elastic interactions of photons with a sample. The sample may e.g. be a live tissue, such as a skin region of a human, but it may e.g. also be a fluid, such as a blood sample, a gas, a chemical of unknown composition, or a solid.

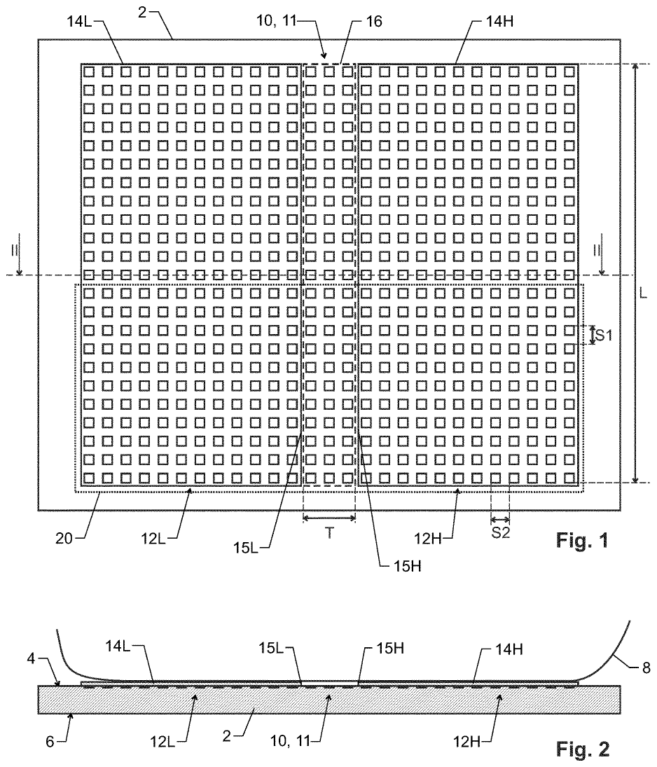

As shown in the example of FIGS. 1 and 2, the device comprises a substrate 2, which is advantageously a semiconductor substrate. It has a first surface 4 and a second surface 6. In operation, first surface 4 typically faces the sample 8 to be investigated.

The device further comprises a plurality of light emitters 10, 11 and a plurality of light detectors 12, all of which are arranged at first surface 4 in the sense that they are adapted to emit light from first surface 4 and to receive light incoming onto first surface 4.

The light emitters 10 are, advantageously, lasers with a narrow-band light emission as defined above. In particular, they are vertical-cavity surface-emitting laser (VCSEL). Alternatively, at least some or all of them may be narrow-band LEDs such as resonant-cavity LEDs (RC-LEDs), for example. Preferably, the light emitters 10 are pre-selected and binned in order to match the required wavelengths. Alternatively, the VCSELs have a built-in tuning capability to achieve the desired wavelength and improve the matching properties. Alternatively, the light emitters are grating couplers of an integrated photonics circuit capable of tuning a plurality of narrowband emissions.

The light detectors 12 may be photodiodes, such as avalanche photodiodes (APDs), silicon photomultipliers (Si PMs) or PIN diodes. In particular, they may be or comprise Single Photon Avalanche Photodiodes (SPADs) for high sensitivity.

In the shown embodiments, the device further comprises a first filter 14H and a second filter 14L.

First filter 14H is arranged at a first set 12H of the light detectors 12 (denoted as 12L, 12H in FIGS. 1 and 2). In the embodiment of FIG. 1, this first set 12H corresponds to the light detectors in the right of the device. As shown in FIG. 2, first filter 14H covers the first set 12H of light detectors.

Similarly, second filter 14L is arranged at a second set 12L of the light detectors 12. In the embodiment of FIG. 1, this second set 12L corresponds to the light detectors in the left half of the device. As shown in FIG. 2, second filter 14L covers the second set 12L of light detectors.

The first and second filters 14H, 14L are arranged on substrate 2 with a gap 16 extending between them. Gap 16 is illustrated, in FIG. 1, as a dashed rectangle. It advantageously forms a rectangular area having a longitudinal extension L parallel to the neighboring edges 15H, 15L of the first and the second filters 14H, 14L and a transversal extension T perpendicular to the neighboring edges 15H, 15L.

In order to arrange the light emitters 10 close to the light detectors, gap 16 is advantageously long and narrow, i.e. the longitudinal extension L along the edges 15H, 15L is advantageously at least 10 times larger than the mutual distance, i.e. the transversal extension T, between these edges 15H, 15L.

The light emitters 10, 11 are advantageously arranged in a two-dimensional array having rows and columns, with the number of rows being advantageously at least five times, in particular at least ten times, larger than the number of columns.

In the shown embodiment, the array has three columns and much more than three rows, in particular at least 10 rows. In the shown embodiment, each row receives three light emitters of specifically matched wavelengths as described in more detail below.

The rows of the array of light emitters extend transversally, in particular perpendicularly, to the longitudinal extension L of gap 16 while the columns of the array extend parallel to the longitudinal extension L. This allows for a simple, repetitive geometry of the light emitters at the region of gap 16 along the longitudinal extension L.

The light detectors 12 are, in the shown embodiment, also arranged in two-dimensional arrays, with each set 12H, 12L forming its own array.

The array of the first set 12H of light detectors 12 is covered by first filter 14H. The array of the second set 12L of light detectors 12 is covered by second filter 14L. The arrays have columns extending parallel to the edges 15H, 15L and rows extending transversally to the edges 15H, 15L.

Advantageously, the rows of the detector arrays as well as the rows of the emitter array have equal spacing S1. This allows, for each row, to arrange at least some light detectors at the same relative position to the light emitters. Thus, the same type of measurements (i.e. with the same relative position between emitters and receivers) can be performed on all rows.

On the other hand, the columns of the detector arrays and the columns of the emitter arrays may have different spacing S2. While the column spacing for the emitters 10, 11 may be chosen to be as small as possible, the column spacing of the detectors 12 primarily depends on the spatial resolution desired “spatially offset” measurements, such as in SORS (see below).

Advantageously, the rows of the arrays of the light detectors 12 extend parallel to the rows of the array of the light emitters 10, 11.

Advantageously, the arrays of the light detectors 12 each comprise at least four columns extending along the longitudinal extension L of the light emitters 10. This allows for spatially offset measurements at at least four distances from the light emitters 10.

### Spectral Design

This section describes various advantageous aspects of the spectral design of the device, i.e. aspects regarding the wavelengths of the various light emitters and filters and their mutual arrangement. The advantages of these design aspects will become more apparent in view of the section “Measurements” below.

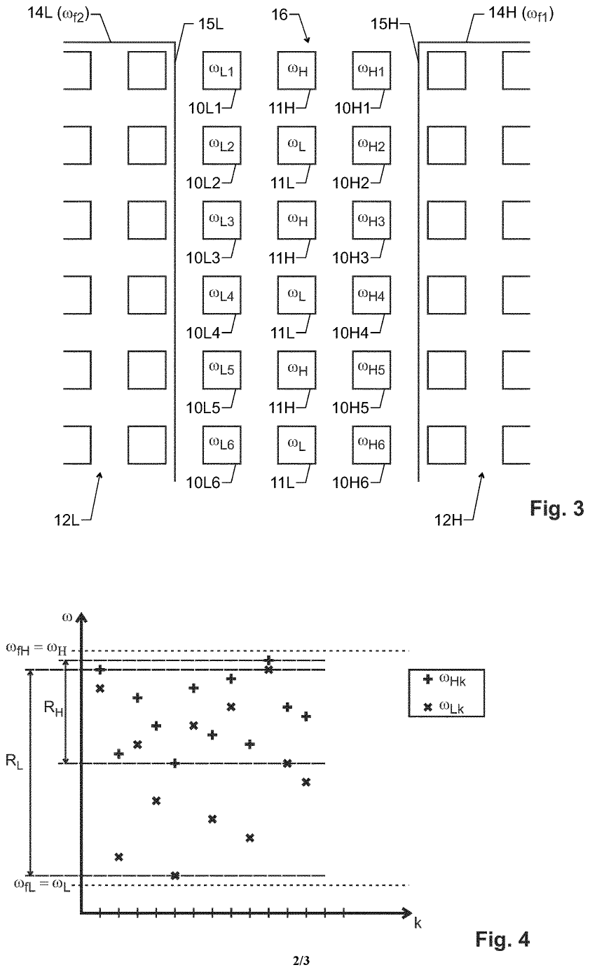

In particular, at least some of the light emitters 12 have, as mentioned above, emission maxima at different frequencies. This is illustrated in FIG. 3, which shows a possible arrangement of the light emitters 12 with their emission maxima.

In particular, the light emitters 10 may include first and second primary light emitters 11H, 11L as well as first and second secondary light emitters 10H1, 10H2, 10H3 . . . 10HK and 10L1, 10L2, 10L3 . . . 10LK with K>1.

In the shown embodiment, there is one primary light emitter 11H, 11L per row, with neighboring rows having different types (first and second) of primary light emitters 11H, 11L.

The first primary light emitters 11H have an emission maximum at an optical frequency ω_{H} and the second primary light emitters 11L have an emission maximum at an optical frequency ω_{L}.

The first secondary light emitters 10Hk (with k=1 . . . K) have emission maxima at optical frequencies ω_{Hk}, and the second secondary light emitters 10Lk (with k=1 . . . K) have emission maxima at an optical frequencies ω_{Lk}.

In the shown embodiment, the primary emitters 11H, 11L are all arranged in a first one of the columns (in the shown embodiment: in the center column) of the array of light emitters. The secondary light emitters 10Hk, 10Lk are arranged in second and third columns (in the shown embodiment: in the outer two columns).

In the shown embodiment, the first secondary light emitters 10Hk are arranged in the second column and the second secondary light emitters 10Lk are arranged in the third column, but this separation of the first and second secondary light emitters 10Hk, 10Lk is not strictly required.

Further, depending on the scope of measurements to be carried out (see below), there may only be one type of secondary light emitters, e.g. the first secondary light emitters 10Hk, and all of them may be arranged in a single column, i.e. the “second” column, only.

In the shown embodiment, the first and second primary emitters 11H, 11L are alternatingly arranged along the first column, thereby evenly distributing them along the length of the array of light emitters 10, 11.

Each row k of the array of the light emitters 10, 11 comprises a primary emitter 11H or 11L as well as first secondary emitter 10Hk and a second secondary emitter 10Lk.

The transmission spectra of the filters 14H, 14L are matched to the emission frequencies on the light emitters 10.

In particular, in the shown embodiment, first filter 14H transmits light at ω_{H} (i.e. light from the first primary light emitters 11H). However, it blocks the light at ω_{Hk} and ω_{Lk} for all k (i.e. the light from all secondary light emitters) as well as the light at ω_{L} (i.e. the light from the second primary light emitters 11L).

Similarly, second filter 14L transmits light at ω_{L} (i.e. light from the first second light emitters 11L). However, it blocks the light at ω_{Hk} and ω_{Lk} for all k (i.e. the light from all secondary light emitters) as well as the light at ω_{H} (i.e. the light from the first primary light emitters 11L).

Advantageously, for a good signal-to-noise ratio, the first and second filters 14H, 14L are bandpass filters having transmission maxima at a first filter frequency ω_{fH} and a second filter frequency ω_{fL}, respectively, in particular with

ω_{fH}=ω_{H} (1)

and

ω_{fL}=ωₗ. (2)

The frequencies ω_{H} and ω_{L} of the first and second primary light emitters are different from each other with ω_{H}>ω_{L}.

The frequencies ω_{Hk}, ω_{Lk} of the secondary light emitters 10Hk, 10Lk lie between ω_{H} and ω_{L}, i.e.

ω_{H}>ω_{HK}>ω_{L} for all k (3)

and

ω_{H}>ω_{LK}>ω_{L} for all k. (4)

For each k, the frequency ω_{Hk} of the first secondary light emitter is larger than the frequency ω_{Lk} of the second secondary light emitter, i.e.

ω_{Hk}>ω_{Lk} for all k (5)

Further, for reasons explained in more detail below, in an advantageous embodiment, ω_{Hk}− _{Lk} is equal to the difference ω_{fH}−ω_{Hk}, i.e.

ω_{Hk}−ω_{Lk}=ω_{fH}−ω_{Hk}. (6)

Advantageously, there is a large number of different frequencies ω_{Hk} and ω_{Lk} for the secondary light emitters in order to perform measurements at a plurality of different points in the spectrum.

In particular, the spectral range R_{L} between a lowest and a highest frequency ω_{Lk}, for all k, is at least 3500 cm⁻¹. And the spectral range R_{H} between a lowest and a highest frequency ω_{Hk}, for all k, is at least 1750 cm⁻¹.

FIG. 4 illustrates an example of the frequencies ω_{Lk} and ω_{Hk} as a function of index k. The figure also shows the spectral ranges R_{L} and R_{H} as well as the frequencies ω_{fH}=ω_{H} and ω_{fL}=ω_{L} of the first and second primary light emitters 11H, 11L and the first and second filters 14H, 14L.

As can be seen, the frequencies ω_{Lk} are advantageously evenly distributed over their spectral range R_{L}, and the frequencies ω_{Hk} are advantageously evenly distributed over their spectral range R_{H}.

In this context, “evenly distributed” advantageously implies that K>3 and that
a maximum distance between any two neighboring values ω_{Lk′} and ω_{Lk″} is no more than 3·R_{L}/(K−1) and/or
the maximum distance between any two neighboring values ω_{Hk′} and ω_{Lk″} is no more than 3·R_{H}/ (K−1).

In this context, the term “neighboring” is to be understood as “next to each other in frequency” and not as “next to each other in index k”.

The above conditions ensure that there are no big gaps in frequency space, i.e. no gaps larger than 3·R_{H}/(K−1).

Using such evenly distributed frequencies allows recording a rich spectrum of the sample.

FIG. 4 assumes that index k corresponds to the row number in the array of light emitters 10, 11. As can be seen from FIG. 4, the frequencies ω_{Lk} and ω_{Hk} are non-monotonous as a function of index k, i.e. they are neither continuously ascending nor continuously descending as a function of k. Rather, the frequencies are un-ordered along x, e.g. they are in a random order. This reduces an unwanted influence of the device or sample geometry on the measured frequency response.

### Measurements

As mentioned, the present device allows to run a variety of different measurements on the sample. All of them are performed by sending light from one or more of the light emitters 10, 11 into the sample and by measuring the light returning from the sample by means of one or more of the light detectors 12. The returning light may e.g. be light reflected from the sample or light transmitted through the ample and returned to the detectors e.g. by mirrors or other deflection means.

The light may interact with the surface of the sample and/or the interior of the sample.

Some of the possible measurements are described in the following.

Spontaneous Stokes or anti-Stokes Raman scattering:

Stokes Raman scattering can be recorded e.g. by emitting light from a single one of the secondary light emitters 10Hk or 10Lk and recording the scattered light by the second set 12L of detectors because second filter 14L blocks the direct light from the secondary light emitters 10Hk and 10Lk but transmits light at the lower frequency ω_{fL}.

Also, spontaneous Stokes Raman scattering can be measured by detecting, by means of the second set 12L of detectors, scattered light from one or more of the first primary light emitters 11H.

Spontaneous anti-Stokes Raman scattering can be recorded e.g. by emitting light from a single one of the secondary light emitters 10Hk or 10Lk and recording the scattered light by the first set 12H of detectors because first filter 14H blocks the direct light from the secondary light emitters 10H and 10L but transmits light at the higher frequency ω_{fH}.

Also, spontaneous anti-Stokes Raman scattering can be measured by detecting, by means of the first set 12H of detectors, scattered light from one or more of the first primary light emitters 11L.

By operating at least one of the secondary light emitters 10Hk, 10Lk and recording the scattered light by means of both the first and the second sets 12H, 12L of light detectors, Stokes as well as anti-Stokes Raman scattering can be measured at the same time.

Instead of operating a single light emitter at a time, several light emitters can be lit at the same time as described in the section “Signal separation” below.

Techniques describing Stokes and anti-Stokes Raman spectroscopy are e.g. described in Dou et al. in Biospec 1997, 3, pp. 113-120.

Hence, advantageously, for measuring spontaneous Stokes or anti-Stokes Raman scattering from the sample, the method includes at least the steps of
emitting light from one or more of the secondary light emitters; and
detecting light from the sample by means of one or more of the detectors.

In particular, for measuring Stokes Raman scattering, the scattered light is detected by one or more of the second set 12L of the detectors. For measuring anti-Stokes Raman scattering, the scattered light is detected by one or more of the first set 12H of the detectors

Elastic scattering, absorption, and/or transmission:

Elastic scattering and/or absorption and/or transmission can be measured by emitting light from one or more of the primary light emitters 11H, 11L and by measuring the light by means of one or more of the detectors 12. This works because the filters 14H, 14L pass light from the corresponding type of primary light emitters.

Hence, the present device is suited to e.g. perform laser absorption spectroscopy, see e.g. Li et al., Remote Sens. 2020, 12(719, 2771 (DOI: 10.3390/rs12172771).

Advantageously, for this type of measurement, the filters 14H, 14L are bandpass filters as specified above with ω_{H}=ω_{fH} and/or ω_{L}=ω_{fL}.

Hence, advantageously, for measuring at least one of elastic scattering, absorption, and transmission, the method includes at least the steps of:
emitting light from one or more of the primary light emitters; and
detecting light from the sample by means of one or more of the detectors.

In particular, the light is emitted from one or more of the first primary light emitters 11H and the scattered light is detected by one or more of the first set 12H of the detectors, and/or the light is emitted from one or more of the second primary light emitters 11L and the scattered light is detected by one or more of the second set 12H of the detectors.

Note that elastic scattering, absorption and/or transmission can also be measured without the filters. In this case, all of the secondary emitters can be used to cover a broad frequency range of elastic scattering measurements.

Coherent anti-Stokes Raman spectroscopy (CARS):

In CARS, a pump beam at frequency ω₁, a Stokes beam at a frequency ω₂, and a probe beam at a frequency ω₃ interact in a stimulated, third-order nonlinear process, generating a coherent signal at the anti-stokes frequency ω₁−ω₂+ω₃. If ω₁−ω₂ corresponds to the energy of a resonant vibrational state of the molecules of the sample, the signal at ω₁−ω₂+ω₃ is strong.

Since the interaction of the pump beam and the Stokes beam has to excite the molecules to an elevated state, ω₁ has to be larger than ω₂.

With the present device, CARS can be implemented by using the light from one of the first secondary light emitters 10Hk for both the pump and probe beams while using the light from one of the second secondary light emitters 10Lk for the Stokes beam, i.e. ω₁=ω₃=ω_{Hk} and ω₂=ω_{Lk}. Hence, the resulting light will have the frequency 2·ω_{Hk}−ω_{Lk}. This light, which has a frequency higher than ω_{Hk} and ω_{Lk}, should pass the high frequency filter, i.e. first filter 14H, in order to be detected by the first set 12H of detectors.

As mentioned above, first filter 14H is advantageously a bandpass filter having a maximum transmission frequency ω_{fH}. Hence, advantageously 2·ω_{Hk}−ω_{Lk}=ω_{fH}, i.e.:

ω_{Hk}−ω_{Lk}=ω_{fH}−ω_{Hk}. (7)

On the other hand, as mentioned above, the maximum transmission frequency ω_{fH} of first filter 14H is advantageously equal to the emission frequency ω_{H} of the first primary emitters 11H, i.e. in an advantageous embodiment we have

ω_{Hk}−ω_{Lk}=ω_{H}−ω_{Hk}. (8)

This corresponds to the frequency distribution illustrated in FIG. 4.

Hence, advantageously, for performing coherent anti-Stokes Raman measurements, the method for operating the device comprises the steps of
concurrently emitting light into the sample from two of the secondary light emitters 10Hk, 10Lk at first and second different optical frequencies, and
detecting light returning from the sample by means of the light detectors 12 at an optical frequency equal to two times the first optical frequency minus one time the second optical frequency.

In this context, advantageously, the first optical frequency is higher than the second optical frequency. In particular, at least one of the first secondary light emitters 10Hk is used to generate the first optical frequency and at least one of the second secondary light emitters 10Lk is used to generate the second optical frequency.

The returning light at two times the first optical frequency minus one time the second optical frequency advantageously corresponds to the maximum transmission frequency ω_{fH} of first optical filter 14H.

Stimulated Raman gain and stimulated Raman loss:

For measuring stimulated Raman gain (SRG) or stimulated Raman loss (SRL), a pump beam at a frequency @1 is sent into the sample together with a Stokes beam at a frequency ω₂. If ω₁−ω₂ corresponds to the energy of a resonant excited state of the molecules of the sample, there is a strong coupling between the two beams resulting in an energy transfer from the pump beam to the Stokes beam. In SRG measurements, the intensity gain of the Stokes beam is detected, in SRL measurements the intensity loss of the pump beam is detected. Advantageously, the loss or gain can be measured by modulating the intensity of one of the beams and detecting this modulation in the other beam, see e.g. Liao et al. in Science Advances 1(9), 2015 (DOI: 10.1126/sciadv.1500738).

With the present device, SRG is measured by using the light from one or more of the second primary light emitters 11L at frequency ω_{L} as the Stokes beam and the light from any of the secondary light emitters 10Hk, 10Lk or of the first primary light emitters 11H as the pump beam. The intensity of the light at frequency ω_{L} returning from the sample is measured by means of one or more of the second set 12L of light detectors.

Similarly, SRL is measured by using the light from one or more of the first primary light emitters 11H at frequency ω_{H} as a pump beam and the light from any of the secondary light emitters 10Hk, 10Lk or of the second primary light emitters 11L as the Stokes beam. The intensity of the light at frequency ω_{H} returning the sample is measured by means of one or more of the first set 12H of light detectors.

A spectrum of SRL and/or SRG can be measured by using several of the secondary light emitters 10Hk, 10Lk for different measurements.

Hence, advantageously, for performing stimulated Raman gain and stimulated Raman loss measurements, the method comprises the steps of
concurrently emitting light into the sample from at least one of the primary light emitters 11H, 11L and from at least one of the secondary light emitters 10Hk, 10Lk and
detecting returning light at an optical frequency of the at least one of the primary light emitters 11H, 11L by means of the light detectors 12.

In particular, the intensity of the at least one of the secondary light emitters 10Hk, 10Lk is electronically modulated, and the signal from the light detectors 12 is analyzed for the modulation in order to detect the gain or loss.

Spatially offset measurements:

Since the device comprises a plurality of light detectors 12 at different distances from the light emitters 10, 11, it can be used to perform spatially offset Raman spectroscopy (SORS) or spatially offset linear interactions or spatially offset fluorescence, which in turn allows to gain information of the internal structure of the sample, see e.g. see e.g. Matousek et al., “Subsurface probing in diffusely scattering media using spatially offset Raman spectroscopy”, Appl. Spectroscopy 59(4), 2005, pp. 393ff as well as WO2006061565A1.

Hence, it is particularly advantageous for the device to comprise at least one two-dimensional array of the first and/or second sets 12H, 12L of the light detectors 12 because such arrays inherently provide detectors at different distances from the light emitters. In this context, the design where several rows of said array(s) of detectors run parallel to a gap 16 at the light emitters 10, 11 is particularly advantageous.

Hence, advantageously, for performing spatially offset measurements, in particular SORS measurements, the method for operating the device comprises the steps of
emitting light into the sample from one or more of the light emitters 10Hk, 10Lk, 11H, 11L and
measuring light returning from the sample by several of the light detectors 12, with said several of the light detectors having different distances from said one or more of the light emitters 10Hk, 10Lk, 11H, 11L.

Fluorescence measurements:

The present device can also be used to perform fluorescence measurements, e.g. as described in https://en.wikipedia.org/wiki/Fluorescence_spectroscopy.

To perform fluorescence measurements, light of at least one of the light emitters, in particular of the first primary light emitters 11H and/or any of the secondary light emitters 10Hk, 10Lk, is sent into the sample, and light at a lower frequency returning from the sample is measured by means of the second set 12L of the light detectors 12. To perform spectral measurements at different wavelengths, light from several of the light emitters at different wavelengths is sent into the sample.

Fluorescence can be distinguished over Stokes Raman emission by its temporal behavior. Whereas Raman is quasi-instantaneous, fluorescence has a characteristic temporal response ranging from nanoseconds to microseconds, which requires fast detectors and fast light pulses to separate the Raman signal from the fluorescence. Aside from the Stokes Raman emission, the fluorescent emission itself is also of value as its lifetime can be an indication of the species to be analyzed in the tissue or sample. More specifically, time-correlated single-photon counting (TSPC) can be employed to assess the temporal behavior of fluorescence. When done spatially, the fluorescence lifetime can be mapped across the tissue or same in a technique called florescence life-time imaging (FLIM). Moreover, SPADs can allow also for time-stamping or time-gating to assess the arrival time of photons. However, since fluorescence often has a significantly higher amplitude compared to the Stokes Raman emission, the Stoke Raman emission is ignored and temporal properties are not used to isolate it further.

Hence, advantageously, for measuring fluorescence properties of the sample, the method includes at least the steps of
emitting light at a first optical frequency from one or more of the light emitters, in particular from the first primary emitters 11H or from one or more of the secondary light emitters 10Hk, 10Lk at a first optical frequency; and
detecting light at a second optical frequency, lower than the first optical frequency, returning from the sample by means of one or more of the light detectors, in particular by means of one or more of the second set (12L) of light detectors (12).

Advantageously, the measurement is performed for several of the light emitters having different optical frequencies. In this case, advantageously, the second filter 14L is a bandpass filter in order to obtain spectral fluorescence information.

As mentioned above, temporal analysis of the returning light may be used, if necessary, to distinguish spontaneous Stokes Raman emission over fluorescence emission.

### Polarized Measurements

The present device may further comprise one or more optical polarization filters arranged at least at some of the light detectors. Such a filter 20 is shown in dotted lines in FIG. 1. It may optionally also extend over at least some of the light emitters 10, 11 in order to polarize the emitted light.

There may be several such polarization filters 20 of different polarization. The filters may be linear or circular polarization filters.

Providing the device with polarization filters makes it possible to perform polarized Raman spectroscopy, as e.g. described in described by Bo Xu et al, J. Phys. Chem. Lett. 2021, 12, 7442-7452 (DOI: 10.1021/acs.jpclett.1c01889).

Hence, advantageously, for performing polarized Raman measurements, the method advantageously comprises the steps of
emitting light into the sample from one or more of the light emitters 10Hk, 10Lk, 11H, 11L and
measuring light returning from the sample by at least some of the light detectors 12, wherein the returning light is filtered by one or more optical polar-izers 20.

### Signal Separation

In the examples above, only one or a few of the light emitters are used at the same time in order to isolate a single photon-matter interaction. Alternatively, though, a larger number of light emitters can be lit at the same time. In this case, the responses of the sample to different incoming light frequencies may e.g. distinguished by electronically modulating the light intensity from the operating light emitters with different modulation frequencies, e.g. in the MHz range, and using electronic frequency filtering for the signals from the light detectors. Said frequency filtering may e.g. be based on PLL detection techniques and/or digital FFT analysis of the measured signals.

Hence, in an advantageous embodiment, the invention relates to a method for operating the device comprising the steps of:
Concurrently operating several of the light emitters 10, 11 while electronically modulating the light intensity of at least two of the light emitters with different modulation frequencies; and
Analyzing signals from the light detectors 12 for frequency components at the different modulation frequencies.

In yet another embodiment, the light emitters 10 may be lit up in a plurality of different patterns, with at least some of said patterns having several of the emitters lit at the same time. In this case, spatially resolved responses from the array(s) of detectors 12 can be spatially analyzed and correlated to each other in order to determine the contributions of the various wavelengths.

### Device Circuitry

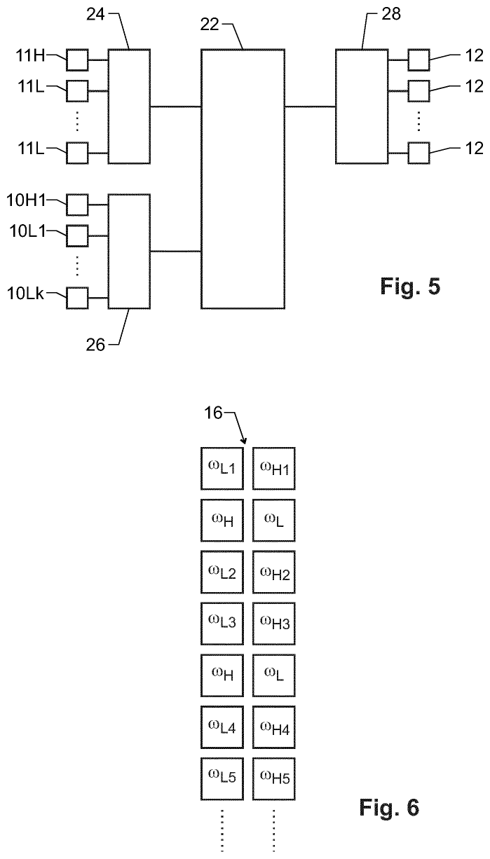

For completeness, FIG. 5 shows an example of the circuitry of a device as described here. It comprises a control unit 22, such as a microprocessor. Control unit 22 is connected to drivers 24, 26 for individually driving the light emitters 10, 11 as well as to circuitry (such as amplifiers and A/D converters) 28 for processing the signals from the detectors 12.

Control unit 22 may be adapted to carry out the methods as described herein, and/or it may interface with an external computer that controls the device for carrying out the methods.

### Notes

In the section “Measurements” above, a number of measurement techniques have been described. Even though these techniques have been described individually, it is also possible to combine them in single measurements.

For example, Stokes or anti-Stokes Raman scattering can be measured concurrently with SORS measurements. Similarly, the elastic techniques (elastic scattering, absorption and transmission) can be combined with SORS measurements. The fluorescence measurements may be combined with any of the Raman measurements. And all measurements can be advantageously combined with polarized measurements.

The above description mentions four types of light emitters, namely the first and second primary emitters 11H, 11L as well as the first and second secondary emitters 10Hk, 10Lk. It must be noted that, in addition to these, the device may comprise further emitters.

For example, as seen in FIG. 4, the density of light emitters in the spectral range R_{H} is higher than in the lower half of the spectral range R_{L}, which leads to a lower spectral resolution of measurements in the lower half of R_{L}. Hence, auxiliary light emitters may be provided with optical frequencies ω_{Ai}, with i=1 . . . I and I>1, in the lower half of R_{L}, for which there is no first secondary light emitter that would fulfill the condition of Eq. (6), i.e. there is no k with ω_{Hk}−ω_{Ai}=ω_{fH}−ω_{Hk}.

Assuming that index k corresponds to the row number in the array of light emitters 10, 11, the secondary light emitters fulfilling Eq. (6) or (7) are arranged in the same row. This is not strictly required. The secondary light emitters 10Hk, 10Lk for a given k may also be arranged in different rows. Advantageously, though, they are located close to each other, e.g. at least in neighboring rows, for having a better overlap of their light fields in the sample.

Hence, advantageously, for any given k, the distance between the first and second secondary light emitter 10Hk, 10Lk is at least five times smaller, in particular at least ten times smaller, than the average of the distances between all pairs {k′, k″} with k′ ≠k″ of first and second secondary light emitters 10Hk′, 10Lk″. First and second filter 14H, 14L can be used to measure, at least in part, different processes as follows:
First filter 14H can, as described above, be used to detect one or more of spontaneous anti-Stokes Raman scattering, SRL, and CARS as well as the measurement of elastic processes at frequency ω_{H}.
Second filter 14L can, as described above, be used to detect one or more of spontaneous Stokes Raman scattering, SRG, and fluorescence measurements as well as the measurement of elastic processes at frequency ω_{L}.

If one group of these measurements is not required, the respective filter and its set of detectors 12 can be dispensed with.

Further, in the examples above, the first and second filters 14H, 14L are bandpass filters. Alternatively, though, e.g. for SRL, first filter 14H may also be a high-pass filter that transmits frequency ω_{H} but blocks at the frequencies of the secondary emitters. Similarly, for SRG, second filter 14L may also be a low-pass filter that transmits frequency ω_{L} but blocks the frequencies of the secondary emitters.

In the embodiments above, the primary emitters 11H, 11L are not covered by any of the filters. Alternatively, though, the first primary light emitters 11H may be covered by the first filter 14H and/or the second primary light emitters 11L may be covered by the second filter 14L.

In the examples above, there are only two types of primary light emitters emitting light at frequencies ω_{H} and ω_{L}. There may, however, also be more than two types of primary light emitters at even further frequencies, e.g. a third type of light emitter at a frequency ω_{H}′ and a fourth type of light emitter at a frequency ω_{L}′ with ω_{H}′≠ω_{H} and ω_{L}′≠ω_{L}.

In the above examples, the number of first primary light emitters 11H and the number of second primary light emitters is the same, and this number is equal to K/2. This is not strictly necessary, though. Advantageously, however, for all k, there is a first and a second primary light emitter close to it. Therefore, if N1 is the number N1 of first primary light emitters and N2 the number of second primary light emitters, both N1 and N2 are advantageously at least as large as K/8, in particular at least as large as K/4.

By way of example, FIG. 6 shows an embodiment of the array of light emitters having only two columns, where the pairs of the first and second primary light emitters are arranged on the same rows, with two rows of secondary light emitters being arranged between each two neighboring rows of first primary light emitters. Further pairs of secondary light emitters may be added. In this case, N1=N2=K/4.

A Raman detection device comprises an array of light emitters including first and second primary light emitters (11H, 11L) and a plurality of secondary light emitters (10Hk, 10Lk), with the optical frequencies of the secondary light emitters (10Hk, 10Lk) lying between the optical frequencies of the primary light emitters (11H, 11L). The array of light emitters is arranged between two arrays of light detectors (12H, 12L). The light detectors (12H, 12L) are covered by two light filters (14H, 14L). The light filters (14H, 14L) are bandpass filters for the frequencies of the first and second primary light emitters (11H, 11L).

While there are shown and described presently preferred embodiments of the invention, it is to be distinctly understood that the invention is not limited thereto but may be otherwise variously embodied and practiced within the scope of the following claims.

1. A Raman detection device comprising
a substrate,
a plurality of narrow-band light emitters integrated on said substrate,
a plurality of light detectors integrated on said substrate, and
at least a first filter arranged at at least a first set of the light detectors,
wherein said light emitters comprise at least one first primary light emitter having an emission maximum at an optical emission frequency ω_{H} and a number K of first secondary light emitters (10Hk), with k=1 to K and K≥1, having an emission maximum at optical emission frequency ω_{Hk}, with ω_{H} ≠ω_{Hk}, for all k=1 to K, and
wherein said first filter transmits light at @H and blocks light at ω_{Hk}.

2-4. (canceled)

5. The device of claim 1
wherein K>1 and
wherein the frequencies ω_{Hk} extend over a spectral range R_{H} of at least 1750 cm⁻¹

6. The device of claim 5 wherein k corresponds to a row number in an array of the light emitters and the frequencies ω_{Hk} are non-monotonous as a function of k.

7. The device of claim 1 wherein ω_{H}>ω_{Hk} for all k.

8. The device of claim 1 comprising K second secondary light emitter(s) having an emission maximum at optical emission frequency ω_{Lk}, with ω_{Lk} being different from ω_{Hk} and from ω_{H}.

9-12. (canceled)

13. The device of claim 8 wherein ω_{Hk}>ω_{Lk} and ω_{H}>ω_{Lk} for all k.

14. The device of claim 8 wherein said first filter is a bandpass filter having a transmission maximum at a first filter frequency ω_{fH} and a FWHM transmission window of less than 100 cm⁻¹ and wherein
ω_{Hk}>ω_{Lk} and
a frequency difference between ω_{Hk} and ω_{Lk} is equal to a frequency difference between ω_{fH} and ω_{Hk}.

15. The device of claim 1 comprising at least one second primary light emitter having an emission maximum at an emission frequency ω_{L}, with of being different from ω_{Hk} and from ω_{H}.

16. The device of claim 15 wherein ω_{H}>ω_{Hk}>ω_{L}.

17. The device of claim 15
comprising K second secondary light emitter(s) having an emission maximum at optical emission frequency ω_{Lk}, with ω_{Lk} being different from ω_{Hk} and from ω_{H},
wherein ω_{H}>ω_{Lk}>ω_{L}.

18. (canceled)

19. The device of claim 1 comprising at least a second filter arranged at at least a second set of the light detectors, wherein said second filter has a transmission spectrum different from the first filter.

20. The device of claim 19 comprising at least one second primary light emitter having an emission maximum at an emission frequency ω_{L}, with ω_{L} being different from ω_{Hk} and from ω_{H},
wherein said second filter transmits light at ω_{L} and blocks light at ω_{H} and ω_{Hk}, and
wherein said first filter blocks light at ω_{L}.

21. (canceled)

22. The device of claim 19
wherein said first filter and said second filter are located, on said substrate, with a gap between then, wherein at least part of said light emitters are located in said gap, and
wherein said gap forms a rectangular area having a longitudinal extension parallel to neighboring edges of the first and the second filters and a transversal extension perpendicular to said neighboring edges.

23. (canceled)

24. The device of claim 22
wherein said emitters are arranged in a two-dimensional array having rows and columns and
wherein said rows extend transversally to the longitudinal extension and said columns extend along the longitudinal extension.

25. The device of claim 24 comprising a plurality of primary emitters and a plurality of secondary emitters, wherein said primary emitters are all arranged in a first one of said columns and said secondary emitters are all arranged in at least a second one of said columns.

26. The device of claim 1 comprising
K second secondary light emitter(s) having an emission maximum at optical emission frequency ω_{Lk}, with ω_{Lk} being different from ω_{Hk} and from ω_{H},
at least one second primary light emitter having an emission maximum at an emission frequency ω_{L}, with ω_{L} being different from ω_{Hk} and from ω_{H},
wherein said emitters are arranged in a two-dimensional array having rows and columns,
wherein the device further comprises
a plurality of primary emitters and a plurality of secondary emitters, wherein said primary emitters are all arranged in a first one of said columns and said secondary emitters are all arranged in at least a second one of said columns,
a plurality of said first and second primary emitters alternatingly arranged along the first column, and
a plurality of said first and second secondary light emitters (10Hk, 10Lk) are arranged along the second and third columns.

27. The device of claim 8
wherein said emitters are arranged in a two-dimensional array having rows and columns and
wherein each row of the emitters comprises a primary emitter, a first secondary emitter, and a second secondary emitter.

28. The device of claim 19 wherein said second set of light detectors comprises a plurality of light detectors arranged in a two-dimensional array covered by said second filter.

29. The device of claim 1 wherein said first set of light detectors comprises a plurality of light detectors arranged in a two-dimensional array covered by said first filter.

30. The device of claim 28
wherein said emitters are arranged in a two-dimensional array having rows and columns,
wherein said first set of light detectors comprises a plurality of light detectors arranged in a two-dimensional array covered by said first filter,
wherein said first set of light detectors comprises a plurality of light detectors arranged in a two-dimensional array covered by said first filter,
wherein said second set of light detectors comprises a plurality of light detectors arranged in a two-dimensional array covered by said second filter
wherein the two-dimensional array of the light emitters, the two-dimensional array of the first set of light detectors, and the two-dimensional array of the second set of light detectors have rows extending transversally to said neighboring edges.

31. (canceled)

32. The device of claim 1 comprising at least one polarization filter arranged at at least some of the light detectors.

33. A method for operating the device of claim 1 comprising
emitting light from at least one of the light emitters into a sample,
measuring light returning from the sample by means of one or more of the light detectors, and
deriving at least one parameter of said sample from a signal of the light detectors.

34. The method of claim 33 comprising the steps of
concurrently operating several of the light emitters while electronically modulating at least two of the light emitters with different modulation frequencies; and
analyzing signals from the light detectors for components at the different modulation frequencies.

35-41. (canceled)
